(19) United States
(12) Patent Application Publication
(10) Pub. No.: US 2026/0094118 A1
(43) Pub. Date: Apr. 2, 2026

(54) ARTIFICIAL INTELLIGENCE-ASSISTED AUTOMATED ANALYSIS AND COMPARISON OF UNSTRUCTURED CONTRACTUAL DOCUMENTS IN VIEW OF CONTRACT STANDARDS

(71) Applicant: Aon Global Operations SE, Singapore Branch, Singapore (SG)

(72) Inventor: Declan Hoare, Dublin (IE)

(73) Assignee: Aon Global Operations SE, Singapore Branch, Singapore (SG)

(21) Appl. No.: 19/336,975

(22) Filed: Sep. 23, 2025

Related U.S. Application Data
(60) Provisional application No. 63/700,118, filed on Sep. 27, 2024.

(51) Int. Cl. G06Q 10/10; G06F 16/31

(52) U.S. Cl. CPC G06Q 10/10; G06F 16/316

(57) ABSTRACT

In an illustrative embodiment, systems for performing automated comparisons of contractual agreements include a vector database storing high-dimensional vectors each representing a translated text section of an unstructured document related to corresponding contractual agreement, a knowledge graph storing a taxonomy and/or ontology of relationships pertinent to a standard document type, a generative AI model tuned to analyze sets of vectors corresponding to a set of documents, a document processing pipeline configured to convert unstructured documents for storage in the vector database, and an AI-enhanced virtual agent configured to automatically compare contents of a set of unstructured documents using vector sets from the vector database and information stored in the knowledge graph.

### RELATED APPLICATIONS

The present application claims priority to U.S. Provisional Patent Application Ser. No. 63/700,118 entitled “Artificial Intelligence-Assisted Automated Analysis and Comparison of Unstructured Contractual Documents in View of Contract Standards” and filed Sep. 27, 2024. The aforementioned application is incorporated by reference herein in its entirety.

### BACKGROUND

Contractual agreements between individuals and/or entities can involve multiple related documents with terms and definitions inherited across. Certain contractual agreements are guided by industry standards and/or governmental requirements. Further, certain agreements may be updated on a periodic basis (e.g., annually) with differences in certain terms and/or “fine print. ” Professionals must carefully scrutinize such contractual agreements to ensure consistency, completeness, and/or adherence to requisite standards.

The insurance industry, for example, is characterized by its reliance on detailed and complex policy documents that outline the terms, conditions, and coverages of insurance agreements. The process of reviewing these documents is critical for insurance brokers, underwriters, and clients to ensure that the policies meet the required standards and accurately reflect the agreed-upon terms. Traditionally, this review process has been manual, involving a line-by-line analysis of the documents by experienced professionals.

In one example, a single policy review can take up to seven hours, making it a resource-heavy task. This time commitment increases exponentially with the volume of policies, leading to significant delays in processing. The manual process limits the ability to quickly scale operations in response to fluctuating demand, such as during peak renewal periods, thus exacerbating delays. Further, manual review involves subjective interpretation on a reviewer-by-reviewer basis, leading to inconsistences in interpretation among a document corpus even with a team of reviewers trained in the same manner on how to conduct the review process. Additionally, human reviewers, despite their expertise, are susceptible to errors, especially when dealing with high volumes of complex information. These errors can lead to misinterpretations of policy terms, thereby creating the risk for potential legal and financial repercussions.

Given these challenges, the inventor recognized a need for innovation in the document review process. In particular, the inventor's goals included significantly reducing the time required to review each set of documents without compromising on thoroughness, minimizing errors and ensuring that document sets are reviewed with a high degree of accuracy and consistency, and providing a solution that can easily scale up or down based on the volume of documents being reviewed.

### SUMMARY OF ILLUSTRATIVE EMBODIMENTS

In one aspect, the present disclosure relates to a pipelined architecture for document ingestion, conversion, storage in vector format, and application to artificial intelligence model(s) to analyze related documents to identify problems. The problems, in some examples, can include errors, omissions, inconsistencies, and/or non-compliance with one or more standards. The related documents, in some examples, can include a set of agreements, proposals, and/or contracts representing a transaction or deal. The related documents, in some illustrative examples, can include insurance and/or reinsurance contracts, mortgage, lease, and/or rental contracts, business loan deals, purchase agreements, and/or contractor bids.

The pipelined architecture, in some embodiments, includes a document processing pipeline for converting the documents into a vector format and storing the vector data, according to contextual relationships within the documents, to a vector database. The document processing pipeline, for example, may format ingested documents into a consistent form. The document processing pipeline may determine partitions within each document aligning with semantic divisions and/or according to contextual relationships, and divide each document in accordance with the partitions into a set of chunks. The document processing pipeline may convert the document chunks into vector form. The processing pipeline may store the vector form of the document chunks according to a vector indexing that captures the contextual and semantic relationships within the set of vectors. In this manner, the pipelined architecture provides a technical solution to the technical problem of identifying, within related documents, similar portions to reference in comparing contents to ensure consistency between sections. Further, in capturing contextual relationships in the manner described herein, the pipelined architecture provides referencing cues for identifying omissions and/or non-compliance within a related document set, thereby providing a technical solution to the technical problem of automatically recognizing completeness in a collection of formal documents.

In some embodiments, the pipelined architecture includes a document comparison pipeline for identifying similarities and differences between two documents, such as changes in terms and/or conditions of an insurance policy between the current year and a prior year. The document comparison pipeline may accept a request from an external user identifying two documents for comparison. The request may include context related to the request, such as a type of document. The document comparison pipeline may collect vector-formatted sections of the documents relevant to the request from the vector database. The document comparison pipeline may arrange the vector-formatted sections in a manner appropriate for receipt to an artificial intelligence network configured to perform vector comparison analysis on documents according to the request context. The document comparison pipeline may engineer one or more AI network prompts designed to request the desired comparison analysis from the AI network. The document comparison pipeline may provide the arrangement of vector-formatted document sections and engineered prompt(s) to the AI network to obtain a document analysis response. The document comparison pipeline may double check the document analysis response to detect any conflicts or inconsistencies in the information provided by the AI network. The document comparison pipeline may attempt to resolve conflicts and/or inconsistencies through further analysis. The document comparison pipeline may format the document comparison response for review by the requesting user, for example in a file or within a graphical user interface presentation.

In some embodiments, the pipelined architecture includes parallel portions of the document comparison pipeline to obtain multiple AI-generated responses. The pipelined architecture may be configured to collect multiple responses, each response from a different document comparison pipeline, and compare the responses to select a final response that is consistent among the responses (e.g., rejecting any outliers). In this manner, the pipelined architecture provides a technical solution to the technical problem of obtaining inaccurate results due to AI hallucinations.

The foregoing general description of the illustrative embodiments and the following detailed description thereof provide mere examples of various aspects of the teachings of this disclosure and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. In the drawings:

FIG. 1 is a flow diagram of an example process for obtaining AI-assisted analysis of a set of documents;

FIG. 2 is a flow diagram of an example process for converting text documents into a vector format and storing for use in automated document analysis;

FIG. 3 is a flow diagram of an example process for performing parallel AI-assisted document analysis to obtain a consistent trustworthy response;

FIG. 4A through FIG. 4D illustrate a flow chart of an example method for performing AI-assisted analysis of a set of documents; and

FIG. 5A and FIG. 5B illustrate example user interface screens for obtaining AI-assisted analysis of a set of documents.

### DETAILED DESCRIPTION OF ILLUSTRATIVE EMBODIMENTS

The description set forth below in connection with the coordinating drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

As used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Further, the terms “approximately,” “about,” “proximate,” “minor variation,” and similar terms generally refer to ranges that include the identified value within some margin, such as, in some examples, 20%, 10%, or 5% in certain embodiments, as well as any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventor intends that that feature or function may be deployed, utilized or implemented in connection with the alternative embodiment unless the feature or function is incompatible with the alternative embodiment.

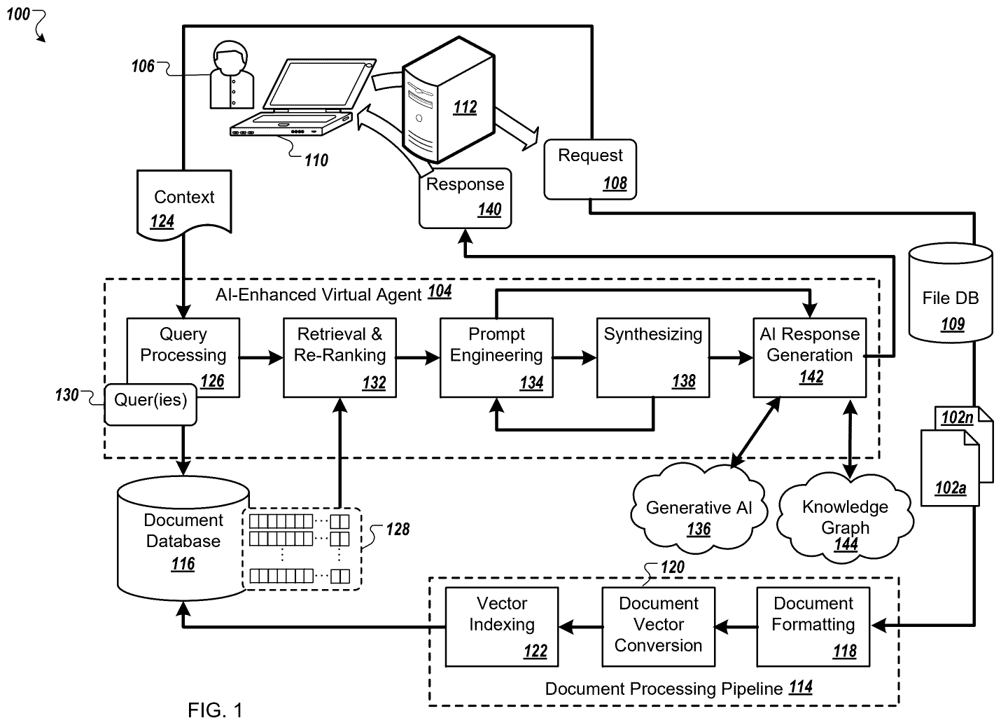

FIG. 1 is a flow diagram of an example system 100 for obtaining AI-assisted analysis of a set of documents 102 from an AI-enhanced virtual agent 104. The set of documents 102, for example, may be submitted by and/or referenced by a user 106 when submitting a request 108 via a remote computing device 110 for AI-assisted analysis.

In some implementations, the request 108 is received by a computing system 112 (e.g., application programming interface (API) server, a server providing portal access to an online platform including the AI-enhanced virtual agent 104, etc.). The computing system 112, for example, may include the processing circuitry of one or more processors configured to provide a front-end user interface to communicating with the AI-enhanced virtual agent 104.

The computing system 112, in some implementations, provides any documents 102 submitted by the user 106 in relation to the request 108 to a document processing pipeline 114 for ingestion into a document database 116. The documents 102 may be stored to a file database 109. The document processing pipeline 114, for example, may be designed to conform each submitted document to a rich data standard, enabling swift and detailed comparisons of portions of each document of a document corpus stored within the document database 116. The document processing pipeline 114, for example, may transform text information, segment by segment, into a corresponding numeric format stored in a high-dimensional vector.

In some implementations, the document processing pipeline 114 includes a document formatting engine 118 configured to convert aspects of each document 102 into a normalized (standardized) format. The document formatting engine 118, in some examples, may correct typographical errors and/or remove certain characters (e.g., special characters, certain types of punctuation, etc.) from each of the documents 102. In another example, the document formatting engine 118 may convert terminology to a consistent spelling (e.g., where a word or term may be presented in multiple forms, such as canceled versus cancelled) and/or consistent phrasing (e.g., lawyer/attorney/“legal counsel” may be consistently reduced to “attorney”). If the document(s) 102 arrive in a form other than raw text, in some embodiments, the document formatting engine 118 converts each document to raw text. In illustration, the text of each document may be converted to a raw character encoding standard (e.g., American Standard Code for Information Exchange (ASCII), ANSI, Unicode, etc.), absent stylization (e.g., underlining, bold, italics, etc.). For any document 102 stored to a graphical format (e.g., some Portable Document Format (PDF) documents), the document formatting engine 118 may extract text using optical character recognition (OCR). The raw text form of the document(s) 102, for example, may be stored in the file database 109 for future reference by the system 100.

In some implementations, the formatted text of each document 102 is converted to vectors by a document vector conversion engine 120. The document vector conversion engine 120, for example, may partition each document 102 into segments and translate the text of each segment to a high-dimensional vector form. Each segment may include, in some examples, at least one word, at least one phrase, at least one sentence, or an entire document section (e.g., paragraph, formal section of a contractual document, etc.). The segments may vary in size/boundary, for example, based on a context of the overall document. For example, parties to an agreement may be separated into individual vectors including a word or phrase (e.g., name of each party), while a definition clause may include the entire text of the definition. The document vector conversion engine 120, in some embodiments, includes contextual cues in the original document 102 and/or context based on a formatting standard for the type of document to divide the document 102 into segments. In some embodiments, the document vector conversion engine 120 assigns a tag to each vector and stores the tag information in relation to the position within the original document in the file database 109 such that the original text may be cross-referenced to its vector form stored in the document database 116. The tags, for example, may be stored in a metadata portion of each file of the file database 109 or in a separate file or files.

In some implementations, a vector indexing engine 122 indexes the high dimensional vectors into the document database 116. The document database 116 (e.g., a vector database) measures similarities based on the vector representations, such that similar information is readily retrieved through the vector indexed storage structure. The vector indexing engine 122 arranges, or clusters, vectors into similarity relationships (e.g., nearest neighbors) within the document database 116 such that, despite the document database 116 containing a very large quantity of data, only one or a comparatively small number of clusters will require searching to retrieve the most similar vector to an input vector (e.g., query).

Returning to the input provided by the user 106 in their request 108, in some implementations, context information 124 is supplied to the AI-enhanced virtual agent 104 for guiding the query response process. The context information 124, in some examples, may specify the type of documents 102 in the request 108 (e.g., types of insurance policy documents, reinsurance policy documents, loan documents, purchase & sale agreement documents, etc.) and/or a purpose (goal) of the request 108. In another example, metadata associated with the files stored to the file database 109 may contain such context. The context information 124, in further examples, can include the identification of one or more entities associated with the provided documents 102, a region associated with the request (e.g., North America, EMEA, APAC, etc.), a language associated with the request, one or more standards applicable to the request, and/or a desired output style for responding to the request (e.g., identification of errors/inconsistencies, recommendation(s) on updating language in view of a recent change in standards, etc.). In some embodiments, a portion o the context information 124 is supplied through a graphical user interface where the user 106 interacts with a set of interactive controls to identify the documents 102 as well as at least one question (e.g., purpose of the request 108) to pose to the AI-enhanced virtual agent 104.

In some implementations, a query processing engine 126 of the AI-enhanced virtual agent 104 obtains the contents of the request 108 including document information (e.g., identifying information for the documents 102 provided in the request 108 or obtained after processing of the documents 102 by the document processing pipeline), the context 124, and/or any further metadata such as identification of the user 106 or requesting computing system 110, etc.). The metadata, for example, may be used to refine a scope of analysis allowable in response to the request 108 (e.g., limited to user 106's access rights to a portion of the documents represented in the document database 116). The query processing engine 126 processes the information to retrieve relevant vector entries 128 from the document database 116. The query processing engine 126, for example, may convert the document identification to a format recognizable by the document database 116 (e.g., a vector format) and/or cross-reference the file database 109 to retrieve the format recognizable by the document database 116.

In some implementations, the document database 116 includes a set of algorithms designed to perform similarity searches based on one or more queries 130 submitted by the query processing engine 126. Different algorithms, for example, may be designed to compare vectors based on different similarity metrics. In an illustrative example, the document database 116 may be designed to perform cosine similarity comparisons.

The document database 116, in some embodiments, provides the relevant vector entries 128 to a retrieval and re-ranking engine 132 of the AI-enhanced virtual agent 104.

The retrieval and re-ranking engine 132, for example, may reorganize the relevant vector entries 128 in accordance with each entry's relevance to the request 108 (e.g., the documents 102 and/or context 124). The retrieval and re-ranking engine 132 may order the relevant vector entries 128 in a manner that better arranges the information for ingestion by a generative AI model to produce the reasoned results analysis desired by the end user 106.

In some implementations, the AI-enhanced virtual agent 104 includes a prompt engineering engine 134 configured to define at least one generative AI model prompt for analyzing the reorganized relevant vector entries 128 in accordance with the purpose identified in the context 124. The prompt engineering engine 134, for example, may access at least one prompt template corresponding to the context 124 and, using at least a portion of the context 124, customize the at least one prompt template to the purposes of the request 108. The prompt engineering engine 134 may then submit the prompt to an AI response generation engine 142 for performing the analysis. In another example, the prompt engineering engine 134 may parse the task of analyzing the reorganized relevant vector entries 128 according to sub-task (e.g., a section-by-section or topic-by-topic comparison/analysis of the documents 102), recursively prompt engineering per sub-task. Further, upon defining a prompt, the prompt engineering engine 134 may provide the prompt to a synthesizing engine 138 for synthesizing the prompt requests prior to submission to the AI response generation engine 142. The synthesizing engine, for example, may compile the engineered prompts for each sub-task and forward the complete set of engineered prompts to the AI response generation engine 142 for prompting at least one generative AI model 136.

In some implementations, the synthesizing engine 138 analyzes the engineered prompt(s) for any ambiguities or discrepancies in the information used to query the system (e.g., the information provided in the context 124). The synthesizing engine 138 may include a feedback loop with the prompt engineering engine 134 to refine the engineered prompt(s) in view of the context of the documents 102 (e.g., as derived from the request 108 and/or the original documents 102 themselves (e.g., as stored in the file database 109). The synthesizing engine 138 may perform additional operations if disambiguation does not appear possible, such as request further information from the end user 106 and/or bifurcate the engineered prompts into two or more query paths to respond to the request 108 with multiple solutions, each based on a different interpretation of the request 108.

One or more engineered prompts, in some implementations, are received by the AI response generation engine 142. The AI response generation engine 142, for example, may prompt the one or more generative AI models 136 with the prompt(s) developed by the prompt engineering engine 134 and/or the synthesizing engine 138. The AI response generation engine 142, further, may reference a knowledge graph 144 to provide ground truth in relation to one or more of the engineered prompts so that the generative AI 136 is applying analysis in accordance with factors applicable to the request. The AI response generation engine 142 may query the knowledge graph 144 using a portion of the context information 124 to obtain the ground truth for the engineered prompt. The knowledge graph 144, in one example, may include ground truth related to various entities (e.g., parties to the documents, such as lenders, insurers, companies, and/or foundations) including relationships among entities (e.g., subsidiary-parent, vendor-client, provider-customer, etc.). In another example, the knowledge graph 144 may include information defining relationships within and among various types of documents, such as, in some examples, a taxonomy and/or ontology of relationships in each type of standard document, such as dependencies between document sections, required terms, etc.

In some implementations, the generative AI 136 receives, from the AI response generation engine 142, the engineered prompt(s), the reorganized vector entries 128, and the ground truth from the knowledge graph 144, and responds with at least one answer (e.g., a separate answer per engineered prompt). The generative AI 136, for example, may include one or more generative AI models, each model trained or tuned to analyze one or more types of documents accepted by the system 100, such as the type(s) of documents represented in the documents 102. The generative AI 136, for example, may have been trained with a set of labeled documents identifying key aspects for review. The key aspects, for example, may include portions of documents historically manually reviewed in confirming consistency, accuracy, and/or completeness of information within a set of documents of a particular type or types. In standardized contracts, for example, this language may include the non-boilerplate portions that are filled in with features specific to a particular deal or agreement. Further, the boilerplate may be analyzed, in some embodiments, to identify any amendment, redaction, or addition to the standard language that parties may have agreed upon. The generative AI 136, in some embodiments, includes one or more large language models (LLMs).

In some implementations, responsive to the engineered prompt(s), the reorganized vector entries 128, and any additional information (e.g., metadata corresponding to the context 124, information derived from the knowledge graph 144, etc.), the generative AI 136 returns a (e.g., a version of a response 140) to the AI response generation engine 142. The response, in some embodiments, includes one or more problems, inconsistences, and/or missing information identified within the documents 102a-n, as recognized through review of the vector formatted versions of the documents 102a-n provided to the generative AI 136 in the reorganized vector entries 128. The response, for example, may reference identifiers associated with one or more of the reorganized vector entries 128 within the response.

The AI response generation engine 142, in some implementations, accesses the original documents 102a-n for cross-referencing with the response prepared by the generative AI 136. The AI response generation engine 142, in some embodiments, prepares a graphical user interface including details of the response prepared by the generative AI 136 as well as at least portions of the original documents 102a-n themselves for use by the user 106 in cross-referencing any problems, inconsistencies, or missing information flagged by the generative AI 136 with the relevant portions of at least one of the documents 102a-n. In other embodiments, data obtained from the generative AI 136 is formatted in the response 140 for transmittal to the computing system 112 and/or the remote computing device 110 for local formatting. The data provided in the response 140, in some examples, may be formatted as comma separated values (CSV) or JavaScript Object Notation (JSON).

In some implementations, the AI response generation engine 142 provides the response 140 to the remote computing device 110 via the computing system 112 for review by the end user 106. The response 140, for example, may be presented at the remote computing device 110 in an interactive user interface, allowing the user 106 to cross-reference each potential error, inconsistency, and/or omission identified by the generative AI 136 with the original documents 102a-n.

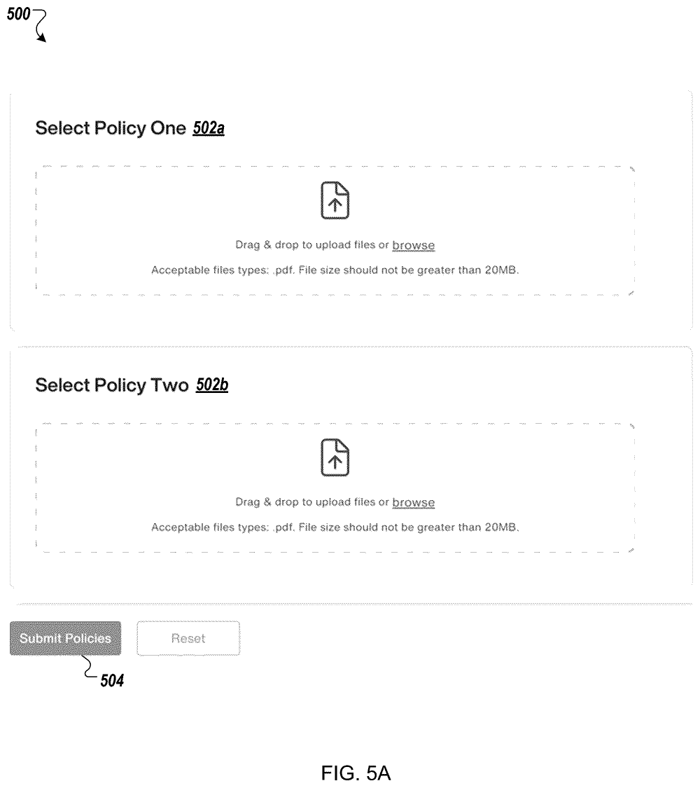

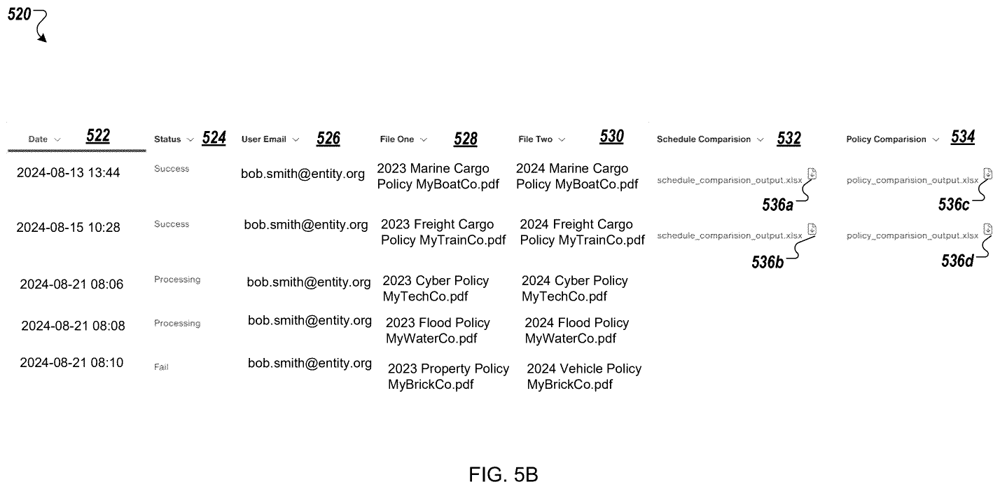

FIG. 5A and FIG. 5B illustrate example user interface screens 500, 520 for obtaining AI-assisted analysis of a set of documents. The example user interface screens 500, 520, for example, may be generated by the system 100 of FIG. 1 (e.g., an interfacing software application or widget executed by the user device 110, a platform application served by computing system 112, etc.).

In some implementations, submitting a request for policy analysis, such as the request 108 of FIG. 1, involves selecting, through a user interface screen 500, a set of policy documents. As illustrated, the user interface screen 500 invites a user to drag & drop or browse to a first policy in a first policy document selection control region 502a and to a second policy in a second policy document selection control region 502b. Further, the user interface screen 500 identifies acceptable file types (in the example illustration, .pdf files) as well as a maximum file size (20 megabytes as illustrated). Once the set of policy documents has been selected, the user may activate a submit policies control 504. Activation of the submit policies control 504, for example, may submit the request (e.g., request 108, including documents 102a and 102b) to the AI-enhanced virtual agent 104 for review.

Turning to FIG. 5B, the example user interface screen 520 illustrates a list of submissions for automated policy comparison. Each submission, for example, may have been provided to the system 100 of FIG. 1 via the user interface screen 500 of FIG. 5A. Each submission is marked with a corresponding timestamp 522, status 524 (e.g., success, processing, or fail), user identifier 526 (e.g., user email), first file identifier 528, and second file identifier 530. The processing, for example, may be performed in near real-time or may take a significant length of time to process (e.g., up to five minutes, five minutes to ten minutes, ten minutes to twenty minutes, up to a half hour, etc.). The length of time for processing, in some examples, may depend on the size of the documents, a queue depth of pending requests, and/or the amount of processing circuitry available to perform the analysis.

For the first two submissions marked with the status 524 of “success”, two outputs 532, 534 are provided—both a schedule comparison 532 and a policy comparison 534. Each output 532, 534 includes a name as well as a link 536a-d to a corresponding document (e.g., an Excel spreadsheet document, as illustrated). The schedule comparison 532, for example, may outline aspects of coverage provided via each of the documents identified by the file identifiers 528, 530. The schedule comparison 532, for example, may relate to amount of coverage, deductibles, limits, exclusions, payment schedules, and/or other conditions related to the topic policy. In other words, the schedule comparison 532 may provide a comparison of the values specific to the topic policy. The policy comparison 534, conversely, may identify any aspects that differ between the “boilerplate” language included in the policies described by the documents identified by the file identifiers 528, 530 (e.g., representations, warranties, and other sections that tend to be substantially standardized across many policies). In other embodiments, a single comparison document may be generated. Further, the comparison documents, in other embodiments, may be formatted in a different manner. In additional embodiments, rather than a document output, a navigable graphical user interface may be presented to the end user, highlighting differences between the two policy documents.

As illustrated in a final row of the user interface screen 520, rather than obtaining outputs such as the schedule comparison 532 and the policy comparison 534, in some embodiments, the process may register failure. Failure may occur, in some examples, due to an incorrect document upload (e.g., not a policy document), mismatching documents uploaded (e.g., as illustrated a 2023 property policy and a 2024 vehicle policy have been provided), and/or unknown types of documents uploaded (e.g., an insurance policy type not recognized by the system). The user may further be presented with a warning or reason for failure in these circumstances (e.g., in a pop-up pane, via correspondence to the user identifier 526 (e.g., email), etc.).

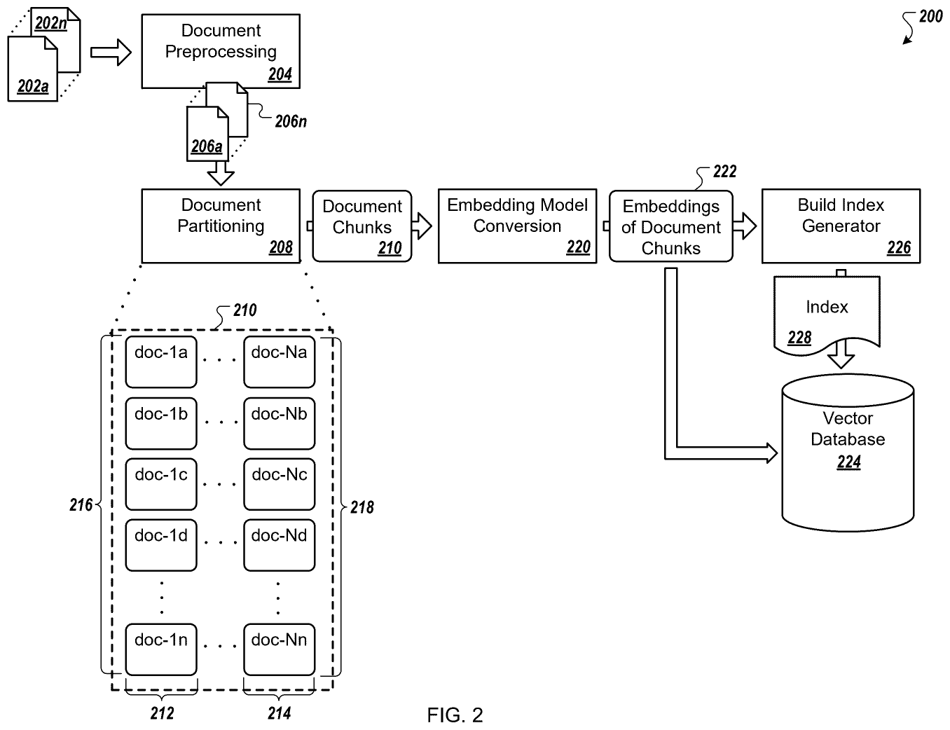

Turning to FIG. 2, a flow diagram illustrates an example process 200 for converting text documents into a vector format and storing for use in automated document analysis. The process 200, for example, may be performed by the document processing pipeline 114 of FIG. 1.

In some implementations, the process 200 begins with receiving, at a document preprocessing engine 204, a set of documents 202a-n. The documents 202a-n, for example, may be the documents 102a-n described in relation to FIG. 1. The documents 202a-n, for example, may be imported from a storage region for use in the system 100. Each of the documents 202a-n, in some embodiments, corresponds to a known (standard) document type, such as a particular style of policy, agreement, and/or contract. Each document 202a-n, for example, may include metadata, a naming convention, a storage convention (e.g., folder name, folder path, etc.), and/or one or more import flags (e.g., set by an end user submitting the documents 202a-n) identifying the document type(s). Further, each documents 202a-n may be formatted in a particular file format of one or more file formats accepted by the process 200. The file format, in some examples, may include PDF, Microsoft® DOCX, OpenDocument (ODF), and/or Rich Text (RTF).

The preprocessing engine 204, in some implementations, conforms the documents 202a-n to a consistent formatting for ingestion into a vector storage format. If the documents 202a-n are in multiple storage types, the document preprocessing engine 204 may convert the documents 202a-n to a single file type. As described in relation to the document formatting engine 118 of FIG. 1, in some examples, the document preprocessing engine 204 may correct typographical errors, remove certain characters, and/or convert words or phrases to consistent terminology. The document preprocessing engine 204 may rely on a knowledge base, such as the knowledge graph 144 of FIG. 1, to perform replacements of words and/or phrases to provide for consistent terminology without losing aspects relevant to the purpose or intent of the underlying document types. The preprocessing engine 204 may convert the documents 202a-202n to a set of formatted documents 206a-n.

In some embodiments, the preprocessing engine 204 applies one or more tokenizers trained to convert text-based tokens (e.g., words and/or phrases, punctuation, etc.) into sequences of numbers. The tokenizer, for example, may be trained to recognize elements of a type or class of policy document and to consistently convert the elements to a number sequence. For example, each tokenizer may be trained to convert text-based tokens consistent with a likely meaning invoked in the context of the type of document, such as an insurance policy or an insurance policy directed to a certain line of business and/or hazard(s). Each tokenizer, in some examples, may consistently convert certain similar tokens, according to its training, regardless of verb tense, plurality, spelling, and/or application of similar (e.g., swappable) terms.

In some implementations, a document partitioning engine 208 divides each of the formatted documents 206a-n into a set of document chunks 210. The document partitioning engine 208 may first split each document semantically into sections according to the standard document type (e.g., type of policy, agreement, or contract). In splitting the documents, for example, the flow and sections of the type of document being divided (e.g., each of doc-1 212 through doc-N 214) may be identified and parsed out to consistently divide a document of the same type in a same manner for use in semantically comparing to corresponding document wording (e.g., clauses, conditions, etc.). In an illustrative example, a semantic similarity comparison may be performed between sentence vector embeddings to analyze a “flow” between concepts. At the point at which the flow diverges by a threshold level (e.g., the similarity score representing a comparison of sentence N to sentence N+1 diverges past a predetermined threshold), a new section may be created. After dividing by document sections, portions of each section known to contain discrete clauses or conditions, for example, may be retained in separate chunks, such as chunks 216a-n. of doc-1a 212. Thus, each of the chunks 216a-n may include a varying number of tokens (e.g., words and/or phrases, punctuation, numbers or other values, formatting such as numbering, etc.).

In some implementations, an embedding model conversion engine 220 converts each of the document chunks 210 (e.g., chunks 216a-n of doc-1 212, chunks 218a-n of doc-N 214, etc.) into a corresponding embedding (e.g., high-dimensional data point or vector) having a mathematical form that represents the semantic traits of the phrasing of the document portion (e.g., meaning and context of a corresponding concept) captured within each of the document chunks 210. The embedding model conversion engine 220, for example, includes one or more embedding models (e.g., neural networks) trained or fine-tuned to capture the relevance of the phrasing based in part on the components of the underlying document type. In an illustrative example, a particular embedding model may be trained or fine-tuned to recognize elements of a type or class of policy document. The embedding models, for example, may be trained to recognize entities (e.g., parties to agreements) and/or relationships therebetween, contractual concepts, facts, property values or variables (e.g., terms used as constructs to legally define properties), and/or categories underlying values and/or terms applied to a given document (e.g., term “marine” represents, in the context of the particular document type, an industry). The embedding models, in some embodiments, are trained to recognize aspects of the phrasing of documents based in part on the document section or other formatting context relevant to a particular chunk. For example, the series of chunks may align to a known series of divisions applied to each document of the document type by the document partitioning engine 208. In another example, the document partitioning engine 208 may apply metadata to at least a portion of the chunks 210 assigning a document section or formatting value that cues the embedding model conversion engine 220 to apply a particular embedding model to converting the chunk to a vector form. The embedding model conversion engine 220, for example, converts each of the document chunks 210 to a separate embedding of a set of embeddings of document chunks 222.

In some implementations, the embeddings of the document chunks 222 are stored to a vector database 224. As discussed in relation to the document processing pipeline 114 of FIG. 1, for example, the embeddings of the document chunks 222 may be stored to the document database 116 by the vector indexing engine 122.

A build index generator 226, in some implementations, indexes the embeddings into the vector database 224 in a manner that applies knowledge of the methods used by the document partitioning engine 208 to section the original documents 102a-n and split concepts within each section into chunks, thereby arranging the embeddings of document chunks 222 within the vector database 224 in a manner that syntactically aligns similar sections and concepts from the original documents 206a-n, allowing for more rapid comparison and enhanced similarity retrieval. The build index generator, for example, may apply a detailed insurance taxonomy and ontology, extracted from historic policy documents, to enable graph-based retrieval according to the relationships found within policy documents. The taxonomy and ontology, for example, may be used to create relationships using graph machine learning techniques, translating the embeddings of document chunks 222 into tuples that map relationships between entities (e.g., nodes, edges, and connections defining policy-based relationships between insurance policy-related entities). The build index generator 226, for example, may provide the vector database 224 with an index 228 (e.g., mapping instructions) for storing the embeddings of document chunks 222.

Although illustrated as separate items, in some embodiments, the embedding model conversion engine 220 and/or the build index generator 226 are part of the vector database 224. For example, the vector database 224 may include built-in functionality to perform embedding and/or indexing algorithms for converting the document chunks 210 into stored vectors.

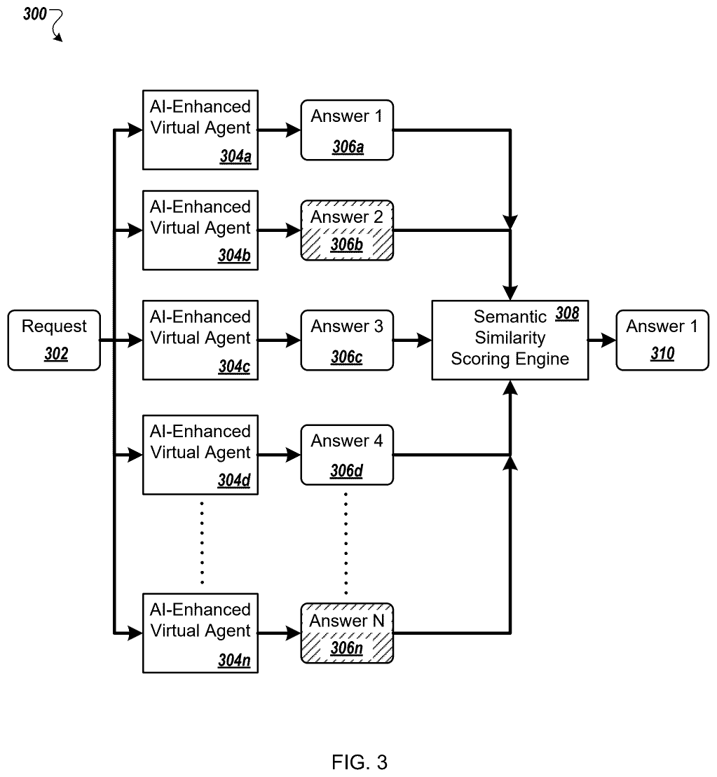

Generative AI, while providing powerful solutions based on analyzing similarities in objects, lacks the consistency of results of prior technology, such as machine learning algorithms. Further, in some circumstances, generative AI can provide misleading or incorrect results, often referred to as hallucinations. The misleading or incorrect results, in some examples, may stem from incorrect assumptions applied in performing the analysis, an insufficiency in training data related to an incoming query, and/or underlying problems within the training data itself. While the methods and systems described herein address some of these concerns through controlled document ingestion (e.g., by the document processing pipeline 114 of FIG. 1), application of additional ground truth (e.g., stored within the knowledge graph 144), and controlled prompt engineering (e.g., by the prompt engineering engine 134 of FIG. 1), to further increase dependability of results, in some implementations, a single request 302 may be submitted concurrently to multiple AI-enhanced virtual agents 304a-n, as illustrated in an example process 300 of FIG. 3, to obtain a consistent trustworthy answer 310.

Turning to FIG. 3, in some implementations, each of the AI-enhanced virtual agents 304a-n are constructed in a similar fashion to the AI-enhanced virtual agent 104 described in relation to FIG. 1. Each of the AI-enhanced virtual agents 304a-n, further, may retrieve relevant vector entries from the same vector database (or a copy thereof), such as the vector entries 128 retrieved from the document database 116 as described in relation to FIG. 1. Further, each of the AI-enhanced virtual agents 304a-n may obtain ground truth from the same knowledge graph (or a copy thereof), such as the knowledge graph 144 of FIG. 1. The generative AI model(s) applied by each of the AI-enhanced virtual agents 304a-n (e.g., the generative AI model(s) 136 of FIG. 1) may be trained and/or tuned in an identical fashion.

In some implementations, responsive to the request 302, each AI-enhanced virtual agent 304a-n produces a corresponding answer 306a-n. As illustrated, Answer 2 306b and Answer N 306n are illustrated as shaded. These two answers 306b, 306n, for example, may lack general conformity with the remaining answers (e.g., Answer 1 206a, Answer 3 306c, Answer 4 306d and any other answers between Answer 4 306d and Answer N 306n).

All of the answers 306a-n, in some implementations, are analyzed by a semantic similarity scoring engine 308 to select a final answer 310 (e.g., Answer 1 306a, as illustrated). The semantic similarity scoring engine 308, for example, may discard one or more answers (e.g., anomalous responses) 306a-n strongly dissimilar to a majority of the answers 306a-n. In illustration, after the AI-enhanced virtual agents 304a-n have generated answers 306a-n to the same request 302 five times, it is unlikely that each answer will differ dramatically from the next. Instead, one or possibly two dissimilar answers 306a-n may be identified and discarded, thereby increasing confidence in the accuracy of the similar answers (e.g., Answer 1 306a, Answer 3 306c, and Answer 4 306d). The semantic similarity scoring engine 308, for example, may compare the vectors applied in generating answers 306a-n mathematically (e.g., in a manner similar to vector database query analysis) to identify the most similar answers 306a-n. The semantic similarity scoring engine 308, for example, may score each answer 306a-n in comparison to the other answers 306a-n to identify the answer conforming with the most common solution. The semantic similarity scoring engine 308 may provide the answer having the most commonalities among the group of answers 306a-n as the final answer 310.

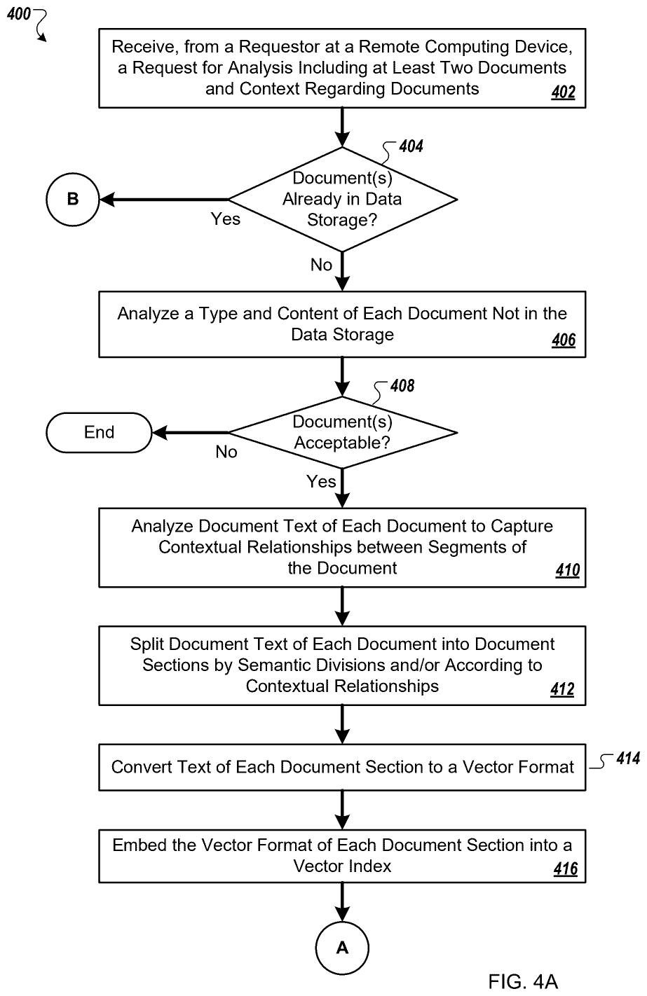

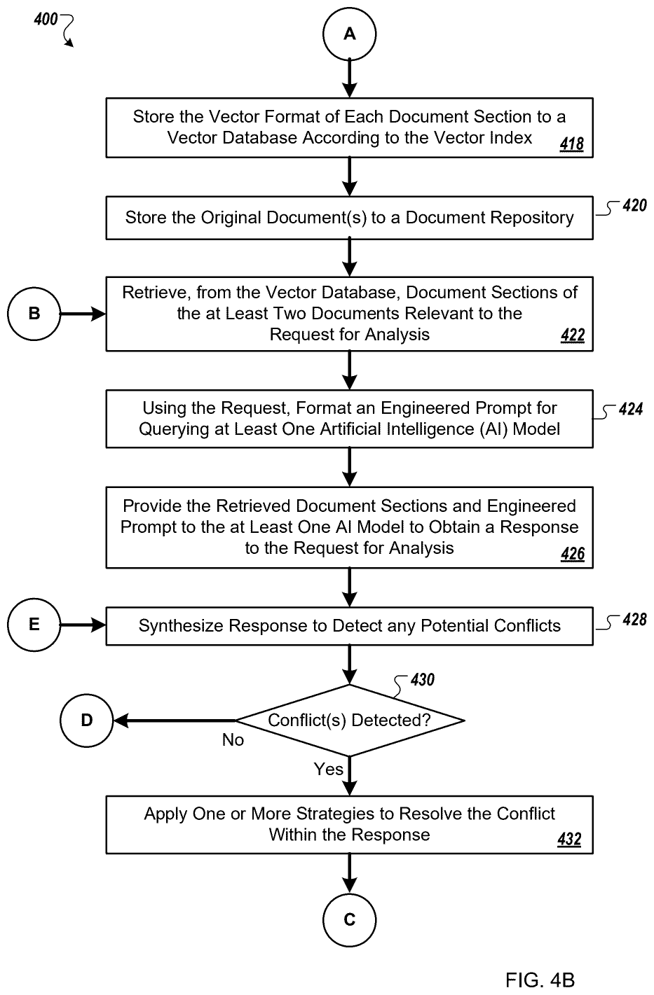

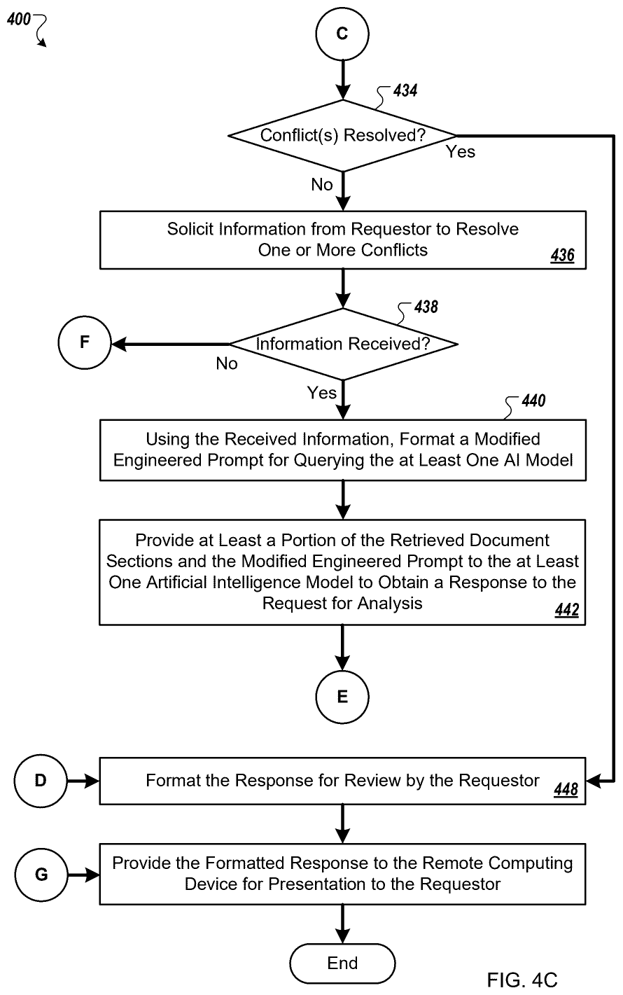

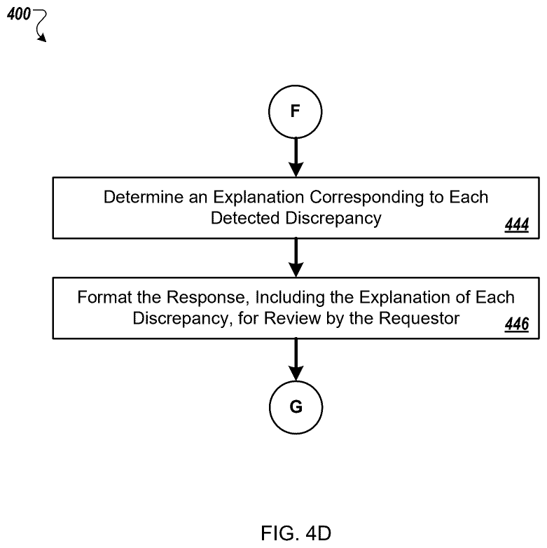

FIG. 4A through FIG. 4D illustrate a flow chart of an example method 400 for performing AI-assisted analysis of a set of documents. The method 400, for example, may be performed by portions of the system 100 of FIG. 1 and/or the process 200 of FIG. 2.

In some implementations, the method 400 begins with receiving, from a requestor at a remote computing device, a request for analysis including at least two documents and context regarding the documents (402). The two or more documents may be submitted along with the request, or the request may include identification of the two documents (e.g., already ingested by the system and stored in a region accessible for analysis). The documents, for example, may be the documents 102a-n of FIG. 1 and/or the documents 202a-n of FIG. 2. The context, for example, may include a type of document (e.g., a type of policy). The context may be included in the documents themselves, for example as metadata or flagged in a naming convention of each electronic file. In some embodiments, the context is derived from the manner of the request submission itself (e.g., the request 108). For example, a web page or platform interface used for the submission may be associated with a particular document type, or a control within the submission interface may be selected to identify the document type. In other embodiments, the system may be designed to analyze a single document type, such that no context information is needed. The context, for example, may be the context 124 of FIG. 1.

In some implementations, if the documents are not within system-accessible data storage (404), a type and content of each document that was not within the system-accessible data storage is analyzed (406). For example, if the documents belonging to the request 108 are not yet in the file database 109 of FIG. 1, the documents may be analyzed for compatibility with analysis. In some examples, the document may be analyzed for language compatibility, document type compatibility, document layout compatibility, file type compatibility, and/or document size/length compatibility. If one or more of the documents is found to be unacceptable (408), in some implementations, the method 400 concludes. For example, the request may be deemed to have failed, as in the request having the fail status 524 in FIG. 5B. The user may be alerted regarding the failure. The alert may include a reason for failure (e.g., problem with one or more of the documents).

In some implementations, when the document(s) have been deemed acceptable (408), the document text of each document is analyzed to capture contextual relationships between segments of the document (410). The document segments (e.g., formatting sections, individual contractual clauses, etc.), for example, may be identified based on a flow of the text of the document. Further, terminology and phrasing that follow between segments (e.g., such as a terminology definition in a definition clause followed by application of the terminology in another clause) may be captured as contextual relationships spanning segments. The text may be analyzed, for example, as described in relation to the document partitioning engine 208 of FIG. 2.

In some implementations, the document text of each document is split into document sections by semantic divisions and/or according to contextual relationships (412). Using the segment identification and contextual relationships, for example, the document text may be split at logical divisions for semantic storage. The splitting, for example, may be performed by the document partitioning engine 208, resulting in the document chunks 210.

In some implementations, the text of each document section is converted to a vector format (414). Each chunk, for example, may be converted to one or more vectors. The vector conversion may be performed by the document vector conversion engine 120 of FIG. 1 and/or the embedding model conversion engine 220 of FIG. 2.

In some implementations, the vector format of each document section is embedded into a vector index (416). The build index generator engine 226 of FIG. 2, for example, may embed the vector format(s) of each document section into the index 228.

Turning to FIG. 4B, in some implementations, the vector format(s) of each document section are stored to a vector database according to the vector index (418). The build index generator engine 226 of FIG. 2, for example, stores the vector format(s) of each document section to the vector database 224 according to the vector index 228.

In some implementations, the original documents are stored to a document repository (420). The documents provided in relationship to the request, for example, may be stored to the file database 109 of FIG. 1. The documents may be stored for later cross-referencing with the performed analysis. In another example, the documents may be stored for performing future analysis. In illustration, as shown in FIG. 5B, the first document identifier 528 corresponding to each request is a 2023 policy, while the second document identifier 530 corresponding to each request is a 2024 policy. For the next year, the 2024 policy may be maintained on file such that only the 2025 policy requires intake by the system. For example, the document may be stored in an original form (e.g., as supplied by a user) and/or in a formatted form (e.g., as described in relation to the document formatting engine 118 of FIG. 1). Further, reference to the indexing of the vector formats of the document contents may be stored in relation to the documents (e.g., as metadata) such that the document's contents may be swiftly cross-referenced within the vector database (e.g., to confirm retention from the prior year).

In some implementations, whether or not the document(s) were located in data storage (404), document sections of the at least two documents relevant to the request for analysis are retrieved from the vector database (422). As described in relationship to FIG. 1, for example, the vector-formatted document sections may be stored to the document database 116 by the document processing pipeline 114 and retrieved from the document database 116 by the AI-enhanced virtual agent 104. The document retrieval, for example, may be performed in relationship to the context 124 of the request 108 by the query processing engine 126 which converts relevant information contained within the request 108 to at least one query 130 configured to retrieve the relevant information.

In some implementations, using the request, an engineered prompt is formatted for querying at least one artificial intelligence (AI) model (424). The prompt engineering engine 134 of FIG. 1, for example, may produce at least one engineered prompt for querying the generative AI model(s) 136, as described in relation to FIG. 1.

In some implementations, the retrieved document sections and the engineered prompt(s) are provided to the at least one AI model to obtain a response to the request for analysis (426). The engineered prompt(s), along with the retrieved vector entries 128, may be provided to the generative AI model(s) 136 by the AI response generation engine 142, for example, as described in relation to FIG. 1.

In some implementations, the response to the request for analysis is synthesized to detect any potential conflicts within the information (428). The vector representations of the chunks used by the AI model(s) in generating the response, for example, may be compared to identify discrepancies between the information related to the engineered prompt(s) (e.g., the truth data supplied within the request to the AI model(s)) and the analysis supplied by the AI model(s) (e.g., the policy comparison results).

If one or more conflicts are detected (430), in some implementations, one or more strategies are applied to resolve the conflict within the response (432). The strategies may vary depending on the type of conflict and/or type of information involved in the conflict (e.g., variable terms in the policy as compared to the verbose standardized language, etc.). The AI response generation engine 142 of FIG. 1, for example, may perform conflict resolution prior to returning the finalized response 140.

In one example, upon detection of a conflict, the conflicting information may be cross-referenced with other policy sections to come to a consensus regarding the appropriate information. For example, a particular term may include a typographical error in one instance within the policy, but the term may be used multiple times throughout the policy document, such that a consensus may be reached that the term should be afforded a certain value. In a simple illustrative example, a numeric value may have inadvertently been translated into a string value due to an optical character recognition mistake that resulted in an “O” within one instance of the term rather than a “0.”

In a second example, conflicting information may be cross-referenced with one or more external knowledge sources to determine the most accurate data. The external knowledge source(s), for example, may include information gathered into the knowledge graph 144, described in relation to FIG. 1. For standardized policy documents, for example, the external knowledge source(s) may provide a taxonomy of relationships within the type of document being analyzed, including, for example, taxonomies specific to various timeframes of the documents (e.g., the 2023 relationships & layout of the standardized format, the 2024 relationships & layout of the standardized format, etc.). In this manner, in an illustrative example, the section pulled from to retrieve a particular value for comparison may be double-checked and, if incorrect, the appropriate location or relationship between sections may be identified.

In a third example, where a conflict arises, each option may be evaluated based on one or more factors such as, in some examples, recency of the information, relevance of the information, and/or reliability of the information to the query (e.g., engineered prompt(s)). The factors, for example, may be assigned weights to determine the version of information to use in view of the conflict.

Turning to FIG. 4C, in some implementations, if the conflict was incapable of automatic resolution (434), information is solicited from the requesting user to resolve the conflict(s) (436). A request for feedback, for example, may be presented within the graphical user interface used by the requestor when submitting the request (e.g., at the user device 110 of FIG. 1). The requester, for example, may supply new information or correct an error in the presented information via the graphical user interface.

If information is received in relation to the feedback request (438), in some implementations, a modified engineered prompt for querying the at least one AI model is formatted using the received information (440). The modified engineered prompt, for example, may include the corrected information as truth data (e.g., in lieu of a corresponding portion of the retrieved document sections and/or in addition to the corresponding portion of the retrieved document sections).

In some implementations, at least a portion of the retrieved document sections and the modified engineered prompt are provided to the at least one AI model to obtain a response to the request for analysis (442). The portion of the retrieved document sections, for example, may be only those relevant to a segment of the analysis in which the discrepancy was discovered. In some embodiments, at least a portion of the information received from the requestor is included with the modified engineered prompt.

In some implementations, the method 400 returns to synthesizing the response (428), this time synthesizing the response to the modified engineered prompt.

If, instead, no information is received in relation to the feedback request (438), turning to FIG. 4D, in some implementations, an explanation corresponding to each detected discrepancy is determined (442). The explanation, for example, may define, in a human-comprehensible manner, the nature of each discrepancy or conflict within the information. The explanation may be designed, for example, to provide context to the end user to assist in the end user's resolution of the described problem.

In some implementations, the response, including the explanation of each discrepancy, is formatted for review by the requestor (446). As discussed in relation to FIG. 5B, for example, the response may be formatted in one or more files, such as the schedule comparison files 532 and the policy comparison files 534. In other embodiments, the response is formatted for review within a software application or computer-generated portal, for example in a navigable online document or other interface.

Turning to FIG. 4B, if, instead, no conflict was discovered (430), in some implementations, the response is formatted for review by the requester (448) as illustrated in FIG. 4C. The response may be formatted as described in relation to operation 446, except for the inclusion of the explanations of each discrepancy.

In some implementations, whether or not any conflicts were identified or addressed, the formatted response is provided to the remote computing device for presentation to the requestor (450). As illustrated in FIG. 5B, for example, the formatted response may be provided in a link to a response document. In other embodiments, the formatted response may be provided in an email, an email attachment, or in near real-time within an interactive graphical user interface.

Although described in relation to a particular set of operations, in other embodiments, the method 400 may include more or fewer operations. For example, in certain embodiments lacking a feedback loop for requestor input, rather than soliciting information (436), the method 400 may proceed to determining an explanation corresponding to each detected discrepancy (444). Additionally, although described in a particular order of operations, in other embodiments, certain operations of the method 400 may be performed in a different order and/or concurrently. For example, sections of the first document may be converted to vector format (414) while additional the second document is being split into document sections (412). Other modifications to the method 400 are possible.

Reference has been made to illustrations representing methods and systems according to implementations of this disclosure. Aspects thereof may be implemented by computer program instructions. These computer program instructions may be provided to a processor of a general-purpose computer, special purpose computer, or other programmable data processing apparatus and/or distributed processing systems having processing circuitry, such that the instructions, which execute via the processor of the computer or other programmable data processing apparatus, create means for implementing the functions/operations specified in the illustrations.

One or more processors can be utilized to implement various functions and/or algorithms described herein. Additionally, any functions and/or algorithms described herein can be performed upon one or more virtual processors. The virtual processors, for example, may be part of one or more physical computing systems such as a computer farm or a cloud drive.

Aspects of the present disclosure may be implemented by software logic, including machine readable instructions or commands for execution via processing circuitry. The software logic may also be referred to, in some examples, as machine readable code, software code, or programming instructions. The software logic, in certain embodiments, may be coded in runtime-executable commands and/or compiled as a machine-executable program or file. The software logic may be programmed in and/or compiled into a variety of coding languages or formats.

Aspects of the present disclosure may be implemented by hardware logic (where hardware logic naturally also includes any necessary signal wiring, memory elements and such), with such hardware logic able to operate without active software involvement beyond initial system configuration and any subsequent system reconfigurations (e.g., for different object schema dimensions). The hardware logic may be synthesized on a reprogrammable computing chip such as a field programmable gate array (FPGA) or other reconfigurable logic device. In addition, the hardware logic may be hard coded onto a custom microchip, such as an application-specific integrated circuit (ASIC). In other embodiments, software, stored as instructions to a non-transitory computer-readable medium such as a memory device, on-chip integrated memory unit, or other non-transitory computer-readable storage, may be used to perform at least portions of the herein described functionality.

Various aspects of the embodiments disclosed herein are performed on one or more computing devices, such as a laptop computer, tablet computer, mobile phone or other handheld computing device, or one or more servers. Such computing devices include processing circuitry embodied in one or more processors or logic chips, such as a central processing unit (CPU), graphics processing unit (GPU), field programmable gate array (FPGA), application-specific integrated circuit (ASIC), or programmable logic device (PLD). Further, the processing circuitry may be implemented as multiple processors cooperatively working in concert (e.g., in parallel) to perform the instructions of the inventive processes described above.

The process data and instructions used to perform various methods and algorithms derived herein may be stored in non-transitory (i.e., non-volatile) computer-readable medium or memory. The claimed advancements are not limited by the form of the computer-readable media on which the instructions of the inventive processes are stored. For example, the instructions may be stored on CDs, DVDs, in FLASH memory, RAM, ROM, PROM, EPROM, EEPROM, hard disk or any other information processing device with which the computing device communicates, such as a server or computer. The processing circuitry and stored instructions may enable the computing device to perform, in some examples, the process 200 of FIG. 2, the process 300 of FIG. 3, and/or the method 400 of FIG. 4A through FIG. 4D.

These computer program instructions can direct a computing device or other programmable data processing apparatus to function in a particular manner, such that the instructions stored in the computer-readable medium produce an article of manufacture including instruction means which implement the function/operation specified in the illustrated process flows.

Embodiments of the present description rely on network communications. As can be appreciated, the network can be a public network, such as the Internet, or a private network such as a local area network (LAN) or wide area network (WAN) network, or any combination thereof and can also include PSTN or ISDN sub-networks. The network can also be wired, such as an Ethernet network, and/or can be wireless such as a cellular network including EDGE, 3G, 4G, and 5G wireless cellular systems. The wireless network can also include Wi-Fi®, Bluetooth®, Zigbee®, or another wireless form of communication. The network, for example, may support communications between the user device 110 and the computing system 112 and/or the computing system 112 and the file database 109 and/or the document database 116.

The computing device, in some embodiments, further includes a display controller for interfacing with a display, such as a built-in display or LCD monitor. A general purpose I/O interface of the computing device may interface with a keyboard, a hand-manipulated movement tracked I/O device (e.g., mouse, virtual reality glove, trackball, joystick, etc.), and/or touch screen panel or touch pad on or separate from the display. The display controller and display may enable presentation of the screen shots illustrated, in some examples, in FIG. 5A and FIG. 5B.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended back-up load to be powered.

The functions and features described herein may also be executed by various distributed components of a system. For example, one or more processors may execute these system functions, where the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system, in some examples, may be received via direct user input and/or received remotely either in real-time or as a batch process.

Although provided for context, in other implementations, methods and logic flows described herein may be performed on modules or hardware not identical to those described. Accordingly, other implementations are within the scope that may be claimed.

In some implementations, a cloud computing environment, such as Google Cloud Platform™ or Amazon™ Web Services (AWS™), may be used perform at least portions of methods or algorithms detailed above. The processes associated with the methods described herein can be executed on a computation processor of a data center. The data center, for example, can also include an application processor that can be used as the interface with the systems described herein to receive data and output corresponding information.

The cloud computing environment may also include one or more databases or other data storage, such as cloud storage and a query database. In some implementations, the cloud storage database, such as the Google™ Cloud Storage or Amazon™ Elastic File System (EFS™), may store processed and unprocessed data supplied by systems described herein. The databases may include one or more vector databases organized to store high-dimensional data points each mathematically representing the meaning and context of at least a portion of an original file (e.g., text document, audio file, rich media file, image file, photograph, video file, etc.). The vector database(s), for example, may incorporate a set of search algorithms for performing vector similarity searches such as, in some examples, an exhaustive k-nearest neighbors (KNN) algorithm, an approximate nearest neighbor (ANN) algorithm, a Locality Sensitive Hashing (LSH) algorithm, a Hierarchical Navigable Small World (HNSW), and/or an Inverted File Index (IVF) algorithm. The vector database(s), further, may include an embedded query engine for submitting a request to the vector database(s). Unlike traditional databases and query systems, for example, a vector database query may respond with a set of similar assets (e.g., objects or items) to the query information based on similarity metrics (e.g., as calculated by the set of search algorithms). The vector database(s), in some examples, may be implemented by Microsoft® Azure Cosmos DB or Cloudflare Vectorize by Cloudflare, Inc. of San Francisco, CA. For example, the contents of the file database 109 and/or the document database 116 of FIG. 1, and/or the vector database 224 of FIG. 2 may be maintained in a database structure.

The systems described herein may communicate with the cloud computing environment through a secure gateway. In some implementations, the secure gateway includes a database querying interface, such as the Google BigQuery™ platform or Amazon RDS™. The secure gateway may include a vector database querying interface, such as Microsoft® Azure AI Search or Vertex AI Vector Search by Google®. The data querying interface, for example, may support access by the document processing pipeline 114 and/or the AI-enhanced virtual agent 104 of FIG. 1, and/or the document partitioning engine 208 of FIG. 2.

In some implementations, an edge server is used to transfer data between one or more computing devices and a cloud computing environment according to various embodiments described herein. The edge server, for example, may be a computing device configured to execute processor intensive operations that are sometimes involved when executing machine learning processes, such as certain operations performed by the AI-enhanced virtual agent 104 and/or the document processing pipeline 114 of FIG. 1. An edge server may include, for example, one or more GPUs that are capable of efficiently executing matrix operations as well as substantial cache or other high-speed memory to service the GPUs. An edge server may be a standalone physical device. An edge server may be incorporated into other computing equipment, such as a laptop computer, tablet computer, medical device, or other specialized computing device. Alternatively or additionally, an edge server may be located within a carrying case for such computing equipment. An edge server, in a further example, may be incorporated into the communications and processing capabilities of a mobile unit such as a vehicle or drone, or may otherwise be located within the mobile unit.

In some implementations, the edge server communicates with one or more local devices to the edge server. The edge server, for example, can be used to move a portion of the computing capability traditionally shifted to a cloud computing environment into the local environment so that any computation intensive data processing and/or analytics required by the one or more local devices can run accurately and efficiently. In some embodiments, the edge server is used to support the one or more local devices in the absence of a connection with a remote computing environment. The edge server may be configured to communicate with the one or more local devices directly or via a network. For instance, the edge server can include a private wireless network interface, a public wireless network interface, and/or a wired interface through which the edge server can communicate with the one or more local devices. In some embodiments, certain local devices may be configured to communicate indirectly with the edge server, for example via another local device. Further, the edge server may be configured to communicate with a remote computing (e.g., cloud) environment via one or more public or private wireless network interfaces.

In some implementations, the process 200 of FIG. 2, the process 300 of FIG. 3, and/or method 400 of FIG. 4A through FIG. 4C may be configured to be performed in part by an edge server or a device interoperating with an edge server. The device interoperating with the edge server, for example, may share processing functionality with the edge server via one or more APIs implemented by the processes.

The systems described herein may include one or more artificial intelligence (AI) neural networks for performing automated analysis of data. The AI neural networks, in some examples, can include a synaptic neural network, a deep neural network, a transformer neural network, and/or a generative adversarial network (GAN). The AI neural networks may be trained using one or more machine learning techniques and/or classifiers such as, in some examples, anomaly detection, clustering, and/or supervised and/or association. In one example, the AI neural networks may be developed and/or based on a bidirectional encoder representations for transformers (BERT) model by Google of Mountain View, CA.

The systems described herein may communicate with one or more foundational model systems (e.g., artificial intelligence neural networks). The foundational model system(s), in some examples, may be developed, trained, tuned, fine-tuned, and/or prompt engineered to evaluate data inputs such as the content so the document database 116 and/or the knowledge graph 144 of FIG. 1, and/or the contents of the vector database 224 of FIG. 2. The foundational model systems, in some examples, may include or be based off of the generative pre-trained transformer (GPT) models available via the OpenAI platform by OpenAI of San Francisco, CA (e.g., GPT-3, GPT-3.5, and/or GPT-4) and/or the generative AI models available through Azure OpenAI or Vertex AI by Google of Mountain View, CA (e.g., PaLM 2). The foundational model systems may include a large language model (LLM) developed using a large corpus of documents including the types of documents ingested and analyzed by the system 100 of FIG. 1.

Certain foundational models may be fine-tuned as AI models trained for performing particular tasks required by the systems described herein. Training material, for example, may be submitted to certain foundational models to adjust the training of the foundational model for performing types of analyses described herein.

Multiple foundational model systems may be applied by the systems and methods described herein depending on context. The context, for example, may include type(s) of data, type(s) of response output desired (e.g., at least one answer, at least one answer plus an explanation regarding the reasoning that lead to the answer(s), etc.). In another example, the context can include user-based context such as demographic information, entity information, and/or product information. In some embodiments, a single foundational model system may be dynamically adapted to different forms of analyses requested by the systems and methods described herein using prompt engineering.

While certain embodiments have been described, these embodiments have been presented by way of example only and are not intended to limit the scope of the present disclosure. Indeed, the novel methods, apparatuses and systems described herein can be embodied in a variety of other forms; further, various omissions, substitutions and/or changes in the form of the methods, apparatuses and systems described herein can be made without departing from the spirit of the present disclosure. The accompanying claims and their equivalents are intended to cover such forms or modifications as would fall within the scope and spirit of the present disclosure.

What is claimed is:

1. A system for performing automated comparisons of contractual agreements, the system comprising:
a vector database comprising a plurality of high-dimensional vectors each representing a translated text section of a respective standard document of a plurality of standard documents, each standard document formatted as a respective standard document type of a plurality of standard document types;
at least one knowledge graph, each knowledge graph comprising a taxonomy and/or ontology of relationships pertinent to at least one standard document type of the plurality of standard document types;
at least one generative artificial intelligence (AI) model tuned to analyze sets of high-dimensional vectors corresponding to at least two documents of the plurality of standard documents, each respective set of high-dimensional vectors related to a different document of the at least two documents, wherein
the at least one generative AI model is tuned to i) recognize elements of each respective subject document of the at least two documents by analyzing each respective set of high-dimensional vectors in view of a first respective one or more knowledge graphs of the at least one knowledge graph, ii) identify a respective relevance of phrasing captured within a high-dimensional vector translation of each corresponding phrase of each respective subject document as represented in the respective set of high-dimensional vectors in view of a second respective one or more knowledge graphs of the at least one knowledge graph, and iii) generate a response capturing differences among the at least two documents; and
processing circuitry configured to perform operations comprising
receiving, from a remote computing device on behalf of a requestor, a request for analysis identifying at least two documents of the plurality of standard documents,
retrieving, from the vector database, a plurality of sets of vectors, each set of vectors comprising a respective set of document sections corresponding to each document of the at least two documents, wherein
each set of document sections of the plurality of sets of document sections represents a vector formatting of original text of at least a portion of a corresponding document of the at least two documents relevant to the request for analysis,
formatting an engineered prompt for querying the at least one generative AI model to request analysis of the at least two documents,
providing the plurality of sets of document sections and the engineered prompt to the at least one generative AI model to obtain a comparison analysis,
obtaining, from the at least one generative AI model, a response comprising the comparison analysis, and
formatting the comparison analysis for review by the requestor.

2. The system of claim 1, wherein the processing circuitry is configured to perform further operations comprising:
responsive to obtaining the response, synthesizing the comparison analysis to detect any conflicts; and
responsive to detecting at least one conflict, applying at least one strategy to resolve each conflict of the at least one conflict; and
wherein the comparison analysis is formatted for review after resolving the at least one conflict.

3. The system of claim 2, wherein:
the plurality of sets of document sections and the engineered prompt are provided to at least three generative AI models;
detecting the at least one conflict comprises detecting, from at least three responses obtained from each AI model of the at least three generative AI models, an anomalous response comprising an inconsistent conflict analysis; and
applying the at least one strategy comprises selecting, for formatting as the comparison analysis, a selected comparison analysis from two or more responses of the at least three responses different than the anomalous response.

4. The system of claim 2, wherein applying the at least one strategy comprises cross-referencing conflicting information with known information contained in the at least one knowledge graph.

5. The system of claim 1, further comprising second processing circuitry configured to perform document processing operations, the document processing operations comprising:
accessing a first unstructured document of the at least two documents;
partitioning the first unstructured document into a plurality of document chunks; and
for each respective document chunk of the plurality of document chunks,
a) converting the respective document chunk into a corresponding respective high-dimensional vector of the plurality of high-dimensional vectors, the corresponding respective high-dimensional vector having a mathematical form representing semantic traits of phrasing of the respective document chunk, and
b) indexing the corresponding respective high-dimensional vector to the vector database.

6. The system of claim 5, wherein the document processing operations further comprise, prior to partitioning the first unstructured document, formatting the first unstructured document into a normalized format.

7. The system of claim 5, wherein partitioning the first unstructured document comprises splitting the first unstructured document semantically into sections according to a corresponding document type of the plurality of standard document types.

8. The system of claim 5, wherein partitioning the first unstructured document comprises analyzing document text to capture contextual relationships between pairs of adjacent segments of a plurality of segments of the first unstructured document.

9. The system of claim 5, wherein partitioning the first unstructured document comprises analyzing document text to identify a plurality of semantic divisions corresponding to pairs of adjacent document sections of a plurality of document sections.

10. The system of claim 1, wherein the plurality of standard documents comprises a plurality of insurance policy documents.

11. A system for performing automated comparisons of contractual agreements, the system comprising:
a document processing pipeline configured to convert a plurality of unstructured documents containing contractual agreements for storage in a vector database, the document processing pipeline comprising i) first hardware-based operations coded as first logic circuitry of at least a first portion of one or more processors and/or ii) at least a second portion of the one or more processors executing first software instructions stored to a first non-transitory computing readable medium, wherein the first hardware-based operations and/or the first software instructions are configured to, for each respective unstructured document of the plurality of unstructured documents,
partition the respective unstructured document into a plurality of document chunks, and
for each respective document chunk of the plurality of document chunks,
a) convert the respective document chunk into a corresponding high-dimensional vector having a mathematical form representing semantic traits of phrasing of the respective document chunk, and
b) index the corresponding high-dimensional vector to a vector database; and
an artificial intelligence (AI)-enhanced virtual agent configured to automatically compare contents of a set of documents of the plurality of unstructured documents, the AI-enhanced virtual agent comprising a) second hardware-based operations coded as second logic circuitry of at least a first portion of at least one processor and/or ii) at least a second portion of the at least one processor executing second software instructions stored to a second non-transitory computing readable medium, wherein the second hardware-based operations and/or the second software instructions are configured to
retrieve, from the vector database, a plurality of sets of vectors, each set of vectors comprising a respective set of document sections corresponding to each document of the set of documents, wherein
each set of document sections of the plurality of sets of document sections represents a vector formatting of original text of at least a portion of a corresponding document of the set of documents,
format an engineered prompt for querying at least one generative AI model to request analysis of the set of documents,
provide the plurality of sets of document sections and the engineered prompt to the at least one generative AI model to obtain a comparison analysis,
obtain, from the at least one generative AI model, a response comprising the comparison analysis, and
format the comparison analysis as a human-readable presentation for review by an end user.

12. The system of claim 11, wherein partitioning the respective unstructured document comprises splitting the respective unstructured document semantically into sections according to a corresponding document type of a plurality of standard document types compatible with the AI-enhanced virtual agent.

13. The system of claim 11, wherein partitioning the respective unstructured document comprises analyzing document text to capture contextual relationships between pairs of adjacent segments of a plurality of segments of the respective document.

14. The system of claim 11, wherein partitioning the respective unstructured document comprises analyzing document text to identify a plurality of semantic divisions corresponding to pairs of adjacent document sections of a plurality of document sections.

15. The system of claim 11, further comprising:
a knowledge graph comprising a taxonomy and/or ontology of relationships pertinent to at least one standard document type; and
at least one generative artificial intelligence (AI) model, wherein each AI model of the at least one generative AI model is tuned to
analyze sets of high-dimensional vectors corresponding to at least two subject documents, and
recognize elements of each respective subject document of the at least two subject documents by analyzing each respective set of high-dimensional vectors in view of the knowledge graph.

16. The system of claim 15, wherein each AI model of the at least one generative AI model is further tuned to identify a respective relevance of phrasing captured within a high-dimensional vector translation of each corresponding phrase of each respective subject document as represented in the respective set of high-dimensional vectors in view of the knowledge graph.

17. The system of claim 15, wherein each AI model of the at least one generative AI model is further tuned to generate a response capturing differences among the at least two subject documents.

18. The system of claim 11, wherein the second hardware-based operations and/or the second software instructions of the AI-enhanced virtual agent are further configured to responsive to obtaining the response:
synthesize the comparison analysis to detect any conflicts; and
responsive to detecting at least one conflict, apply at least one strategy to resolve each conflict of the at least one conflict;
wherein the comparison analysis is formatted for review after resolving the at least one conflict.

19. The system of claim 18, wherein the second hardware-based operations and/or the second software instructions of the AI-enhanced virtual agent are further configured to, responsive to detecting a first conflict of the at least one conflict, issue a request to a remote computing device to solicit information from the end user to resolve the first conflict.

20. The system of claim 11, wherein the second hardware-based operations and/or the second software instructions of the AI-enhanced virtual agent are further configured to:
synthesize the comparison analysis to detect any discrepancy; and
responsive to detecting at least one discrepancy, determine an explanation corresponding to each detected discrepancy of the at least one discrepancy;
wherein formatting the comparison analysis comprises including, in the human-readable presentation, a respective explanation corresponding to each detected discrepancy of the at least one discrepancy.
